(19) United States
(12) Patent Application Publication
(10) Pub. No.: US 2017/0162993 A1
(43) Pub. Date: Jun. 8, 2017

(54) BRUSH HOLDER DEVICE AND DC MOTOR EQUIPPED WITH THE SAME

(71) Applicant: MABUSHI MOTOR CO., LTD., Chiba (JP)

(72) Inventor: Atsushi Yoshida, Chiba (JP)

(21) Appl. No.: 15/316,811

(22) PCT Filed: Jun. 25, 2015
(86) PCT No.: PCT/JP2015/068385

§ 371 Date: Dec. 6, 2016

(30) Foreign Application Priority Data
Jun. 25, 2014 (JP) 2014-130380

(51) Int. Cl. H01R 39/38; H02K 5/14; H02K 23/00; H02K 13/10

(52) U.S. Cl. CPC H01R 39/381; H02K 13/10; H02K 5/14; H02K 23/00

(57) ABSTRACT

A brush holder device includes: a pair of brush holders placed on a base to slidably hold brushes, respectively, in directions orthogonal to an outer circumferential surface of a commutator; first and second supporting columns are erected next to each other in a region between the pair of brush holders; and first and second torsion springs including wound portions fit around the respective supporting columns, first ends extend from the wound portions serving as working ends to abut against the respective brushes, and second ends extend from the wound portions serving as reaction ends to be restrained by outer circumferential surfaces of the supporting columns on the respective opposite sides.

### TECHNICAL FIELD

The present invention relates to a brush holder device and a DC motor equipped with the brush holder device, where the brush holder device holds and biases brushes toward a commutator to supply electric power to an armature.

### BACKGROUND ART

Various types of brush are available for use in DC motors (hereinafter referred to as motors) and brushes of the most suitable type are selected and adopted with consideration given to applications and the like of the motor. For example, in a motor for an automotive power window or sunroof, power tool, or the like which requires a relatively large driving force, a brush holder device is used to securely hold large-sized brushes.

FIG. 9 is a plan view showing a brush holder device for a 4-pole motor. In this conventional brush holder device 101, a pair of brush holders 17 are placed on a base 16 at a 90-degree interval around a rotation axis Lc of a commutator 9 and respective brushes 18 are held by the brush holders 17 in such a way as to be slidable in a radial direction of the commutator 9. A pair of supporting columns 25 and 26 are erected in a narrow-angle region of the two brush holders 17 on the base 16, wound portions 27a and 28a of torsion springs 27 and 28 (hereinafter referred to as springs) are fitted around the respective supporting columns 25 and 26, and a partition wall 102 is formed between the two springs 27 and 28 to maintain electrical insulation.

First ends of the springs 27 and 28 abut as working ends 27b and 28b against peripheral edges (on the side opposite the commutator 9) of the brushes 18, and apply set loads to the wound portions 27a and 28a while second ends of the springs 27 and 28 are restrained, as reaction ends 27c and 28c, by the partition wall 102. The working ends 27b and 28b of the springs 27 and 28 are designed to bias the brushes 18 toward the commutator 9 by the elasticity of the wound portions 27a and 28a, thereby supplying electric power to the commutator 9 through the brushes 18.

Also, for example, Patent Document 1 proposes another brush holder device. Again, with a technique according to Patent Document 1, a pair of supporting columns are erected between brush holders placed at a 90-degree interval, a partition wall for electrical insulation is formed between the supporting columns, and a guide wall is erected on a base to restrain reaction ends of torsion springs fitted around respective supporting columns.

Furthermore, Patent Document 2 proposes another brush holder device. With a technique according to Patent Document 2, a pair of brushes are biased by a single spring, and thus a supporting column used to support the spring is also shared. With a wound portion of the spring being fitted around the supporting column, opposite ends of the spring are designed to abut as working ends against peripheral edges of the respective brushes and bias the brushes toward the commutator.

### PRIOR ART DOCUMENT

### Patent Document

Patent Document 1: Japanese Patent Laid-Open No. 2006-320152

Patent Document 2: Japanese Patent No. 4485889

### SUMMARY OF THE INVENTION

### Problems to be Solved by the Invention

Generally, motors are provided with anti-burnout measures and anti-noise measures may be required depending on the application. Consequently, various elements such as an anti-burnout PTC thermistor, anti-noise varistor, ferrite core, capacitor, and resistor are placed on the base of the brush holder device in addition to a brush holder, supporting columns, and springs, leaving little space on the base. Therefore, in order to downsize the motor, it is essential to improve space efficiency on the base and it is an important task to reduce occupation area of members around the supporting columns in particular.

In the case the conventional technique shown in FIG. 9, since the partition wall 102 is formed between the two supporting columns 25 and 26 to electrically insulate the springs 27 and 28 and restrain the reaction ends 27c and 28c, the two supporting columns 25 and 26 cannot be brought close enough to each other by being hindered by the partition wall 102, which cannot be said to be favorable for the reduction of the occupation area and thus downsizing of the motor.

Also, with the technique according to Patent Document 1, since the guide wall is formed to restrain the reaction ends in addition to the partition wall to electrically insulate the springs, the occupation area of members around the supporting columns is still greater than that shown in FIG. 9.

Also, with the technique according to Patent Document 2, the supporting column and spring are shared between the two brushes, which seems, at first glance, to contribute to reduction of the occupation area, but actually could be a contributing factor to upsizing of the motor.

For example, in the conventional technique of FIG. 9, the working ends 27b and 28b of the springs 27 and 28 follow arc trajectories around the supporting columns 25 and 26 (more specifically, leader portions a of the working ends 27b and 28b on outer circumferences of the wound portions 27a and 28a) as indicated by arrows. Therefore, to constantly and properly bias the brushes 18 which shorten gradually due to wear, it is desirable to place the supporting columns 25 and 26 near the midpoint of overall length l in a sliding direction of the brushes 18. This is also true to the technique of Patent Document 2.

Because allowable strokes of the working ends 27b and 28b in the sliding directions of the brushes 18 change with lengths from the wound portions 27a and 28a to the working ends 27b and 28b (=distances between the supporting columns 25 and 26 and the brushes 18), there is a limit to the extent to which the supporting columns 25 and 26 can be brought close to the brushes 18. Because the conventional technique allows positions of the supporting columns 25 and 26 with respect to the respective brushes 18 to be set individually, the supporting columns 25 and 26 can be placed at a location as close as possible to the respective brushes 18 while securing the strokes by correcting for changes in brush lengths due to wear.

However, with the technique according to Patent Document 2, in which a supporting column 201 is shared, because it is necessary to place the supporting column 201 so as to be located at the midpoints of the overall lengths l of both brushes 18 as shown in a schematic block diagram of FIG. 10, the position of the supporting column 201 is inevitably be limited to an intersection of lines extended in an orthogonal direction from the midpoints of the overall lengths l of the two brushes 18. Consequently, the supporting column 201 is disposed at a location spaced away greatly from both brushes 18 and spaced also away from the rotation axis Lc of the commutator 9, leaving no choice but to extend diameter of the base 16 and becoming a contributing factor to upsizing of the motor.

The present invention has been made to solve the above problem and has an object to provide a brush holder device which can reduce occupation area of members around supporting columns erected on a base and thereby downsize a motor as well as to provide a DC motor equipped with the brush holder device.

### Means For Solving the Problems

In order to achieve the above object, an aspect of the present invention is characterized by providing a brush holder device comprising: a pair of brush holders placed on a base to slidably hold brushes, respectively, in directions orthogonal to an outer circumferential surface of a commutator; first and second supporting columns erected next to each other in a region between the pair of brush holders; and first and second torsion springs including wound portions around the respective supporting columns, first ends extended from the wound portions to abut against the respective brushes as working ends, and second ends extended from the wound portions to be restrained by outer circumferential surfaces of the supporting columns on the respective opposite sides as reaction ends.

When the brush holder device is configured as described above, the reaction ends of the torsion springs are restrained by the supporting columns on the respective opposite sides and reaction forces generated when the brushes are biased by the working ends are borne by the supporting columns on the respective opposite sides, eliminating the need to install a partition wall between the first and second supporting columns to restrain the reaction ends and making it possible to bring the two supporting columns close to each other by a distance equivalent to thickness of the partition wall. Also, since the torsion springs are supported on the pair of respective supporting columns, positions of the supporting columns with respect to each of the brushes can be set individually, making it possible to place the supporting columns at appropriate locations close to the brushes and thereby downsize the base.

Another aspect of the present invention is directed to providing a DC motor comprising: a housing; a rotor including a rotating shaft, an armature, and a commutator; and a brush holder device. The brush holder device includes: a base supported by a housing, a pair of brush holders placed on the base to slidably hold brushes, respectively, in directions orthogonal to an outer circumferential surface of the commutator, first and second supporting columns erected next to each other in a region between the pair of brush holders, and first and second torsion springs including wound portions fit around the respective supporting columns, first ends extended from the wound portions to abut against the respective brushes as working ends, and second ends extended from the wound portions to be restrained by outer circumferential surfaces of the supporting columns on the respective opposite sides as reaction ends.

The brush holder device and the DC motor according to the present invention described above can achieve their downsizing, more specifically, can reduce the occupation area of members around the supporting columns erected on the base of the brush holder.

### Advantageous Effects of the Invention

The brush holder device according to the present invention and the DC motor equipped with the brush holder device, can reduce the occupation area of members around the supporting columns erected on the base and thereby downsize the motor.

### BRIEF DESCRIPTION OF THE DRAWINGS

The present invention will become more fully understood from the detailed description given hereinafter and the accompanying drawings which are given by way of illustration:

FIG. 1 is a sectional view showing a motor 1 according to an embodiment.

FIG. 2 is a plan view showing a brush holder device as viewed from a rear side of the motor.

FIG. 3 is a side view of the brush holder device corresponding to a view taken in the direction of arrow A in FIG. 2.

FIG. 4 is a perspective view showing the brush holder device in an assembled state.

FIG. 5 is an exploded perspective view of the brush holder device corresponding to FIG. 4.

FIG. 6 is side view corresponding to FIG. 3, showing how spring wires are arranged in a gap between two supporting columns.

FIG. 7 is a plan view corresponding to FIG. 2, showing a base discretely.

FIG. 8 is a side view corresponding to FIG. 3, showing the base discretely.

FIG. 9 is a plan view showing a conventional brush holder device.

FIG. 10 is a schematic diagram comparing locations of supporting columns between the conventional technique and Patent Document 2.

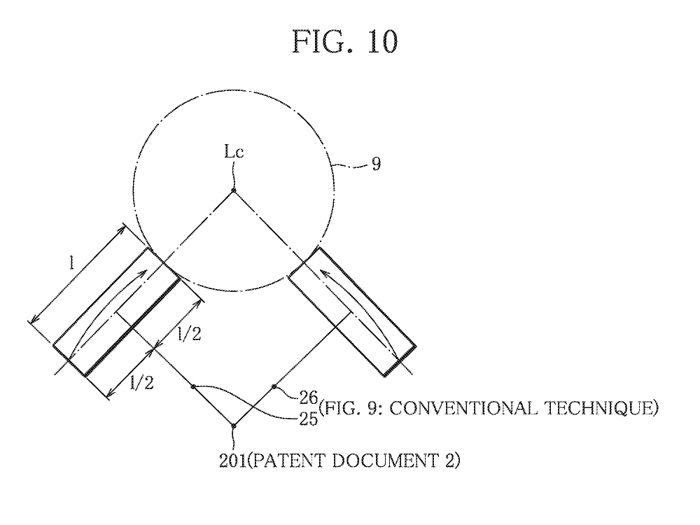

### MODE FOR CARRYING OUT THE INVENTION

A brush holder device which embodies the present invention and an embodiment of a DC motor equipped with the brush holder device will be described. The DC motor of the present embodiment is configured as a 4-pole motor in which a pair of brushes are placed on a base at a 90-degree interval around a rotation axis of a commutator and is used to drive an automotive power window.

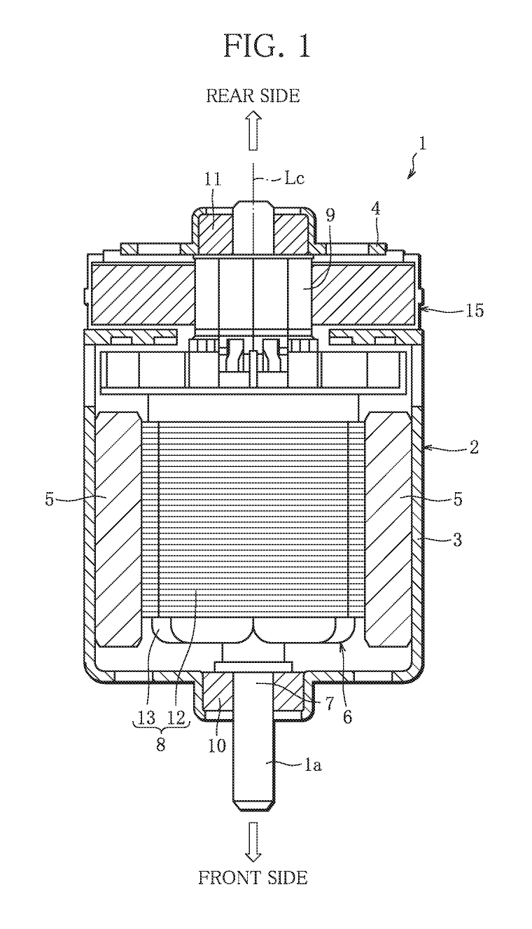

FIG. 1 is sectional view showing the motor 1 according to the present embodiment, where the bottom of FIG. 1 corresponds to a front side of the motor 1 from which an output shaft la protrudes and the top corresponds to a rear side of the motor 1.

A housing 2 of the motor 1 includes a closed-end cylindrical metal case 3 opened toward the rear side and an end plate 4 closing the opening of the case 3. Four-pole field magnets 5 are fixed to an inner circumferential surface of the metal case 3 by adhesive, so that the field magnets 5 function as a stator. A rotor 6 is disposed inside the field magnets 5, where the rotor 6 includes a rotating shaft 7, an armature 8, and a commutator 9.

The front side of the rotating shaft 7 of the rotor 6 is rotatably supported by a bearing 10 provided in the metal case 3, and the rear side of the rotating shaft 7 is rotatably supported by a bearing 11 provided in the end plate 4, where the rotating shaft 7 protrudes toward the front side from the housing 2 to serve as the output shaft 1a. The armature 8 includes a core 12 fixed to the rotating shaft 7 and a winding 13 wound around the core 12, while a predetermined clearance is formed as a magnetic gap between an outer circumferential surface of the core 12 and an inner circumferential surface of the field magnets 5. The commutator 9 is mounted on the rotating shaft 7 on a rear side of the armature 8 and is electrically connected to the winding 13 although not illustrated.

A brush holder device 15 is disposed in the housing 2, containing the commutator 9. A configuration of the brush holder device 15 will be described below.

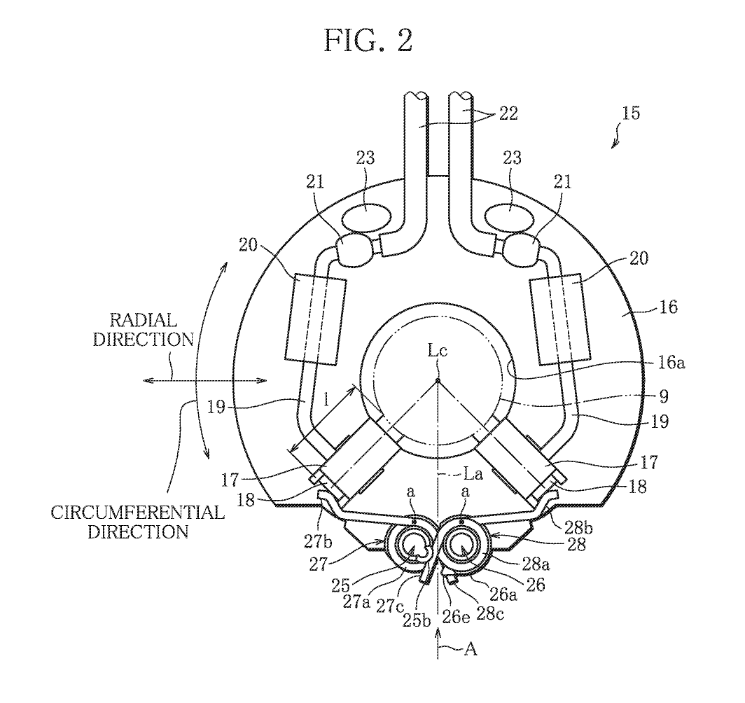

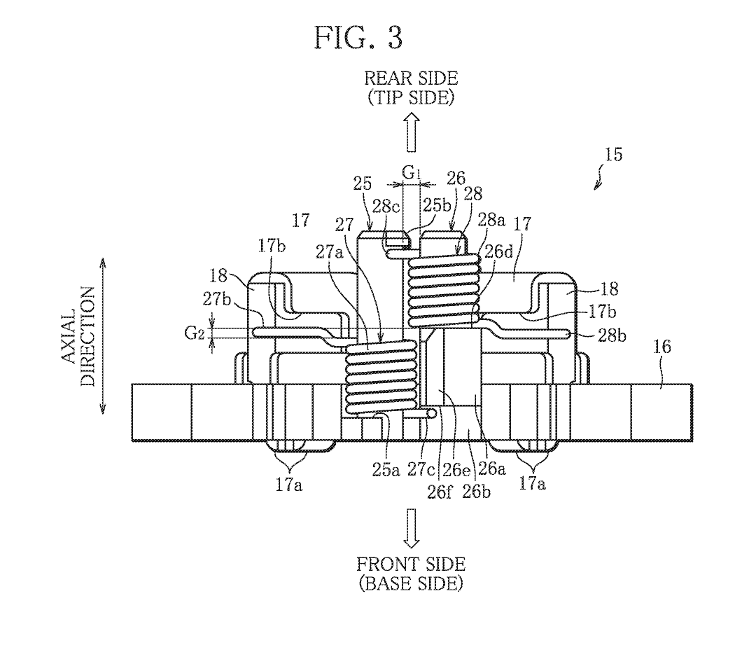

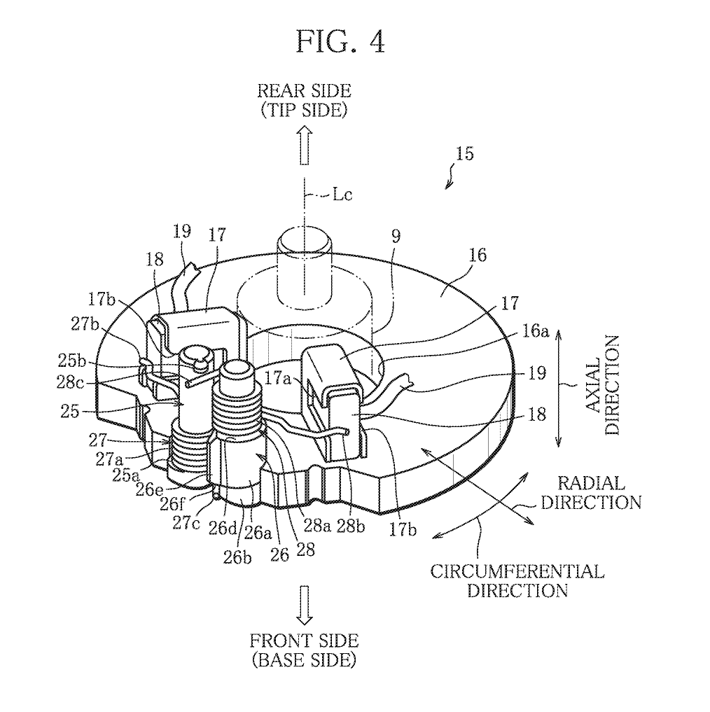

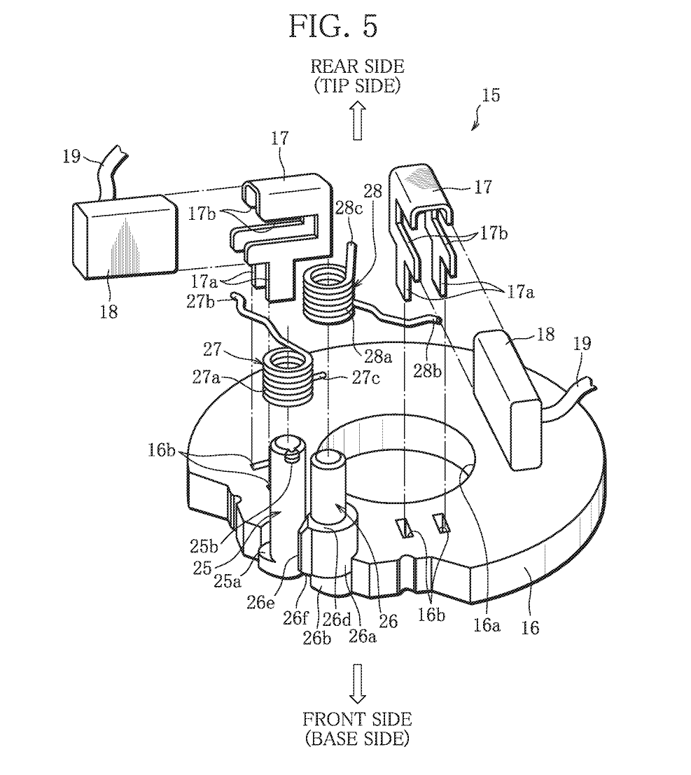

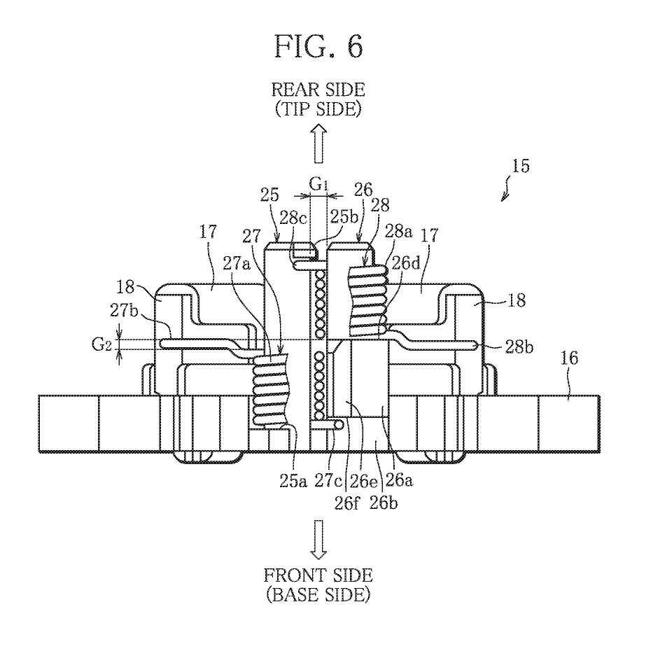

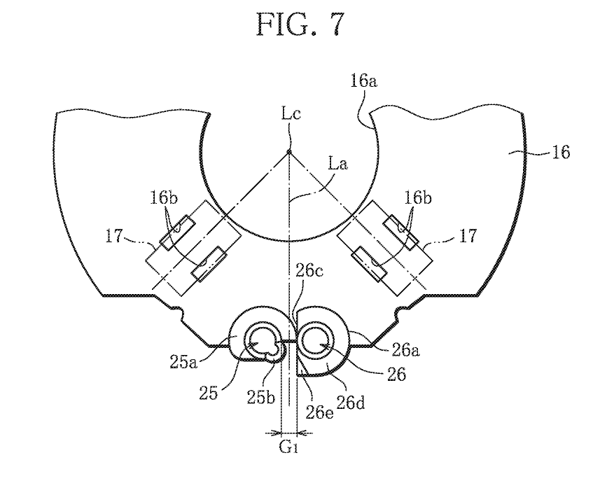

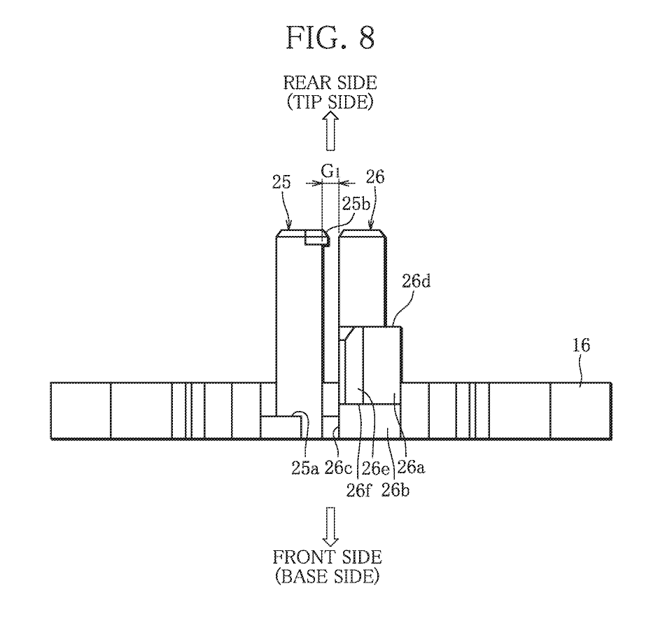

FIG. 2 is a plan view showing the brush holder device 15 as viewed from the rear side of the motor 1, FIG. 3 is a side view corresponding to a view taken in the direction of arrow A in FIG. 2, FIG. 4 is a perspective view showing the brush holder device 15, FIG. 5 is an exploded perspective view corresponding to FIG. 4, FIG. 6 is side view corresponding to FIG. 3, showing how spring wires are arranged in a gap between two supporting columns, FIG. 7 is a plan view corresponding to FIG. 2, showing the base discretely, and FIG. 8 is a side view corresponding to FIG. 3, showing the base discretely, where the tops of FIGS. 3 to 6 and 8 correspond to the rear side of the motor 1.

The brush holder device 15 includes a base 16 corresponding to the rear side of the motor 1 and members such as the brush holders 17 and torsion springs 27 and 28 assembled on a surface of the base 16 (hereinafter referred to as “on the base”) corresponding to the rear side of the motor 1. The base 16 is made of synthetic resin material, shaped like a disk as a whole, and disposed near an opening of the metal case 3. As shown in FIGS. 2 and 4, the commutator 9 of the rotor 6 is passed through a through-hole 16a provided in a center and protrudes slightly to the rear side from the base 16.

In the following description, as shown in FIG. 4, directions on the base 16 are defined as follows: a direction along the rotation axis Lc of the commutator 9 is defined as an axial direction, a direction orthogonal to the rotation axis Lc is defined as a radial direction, and a direction drawing a circular arc around the rotation axis Lc is defined as a circumferential direction.

As shown in FIGS. 2, 4, and 5, a pair of the brush holders 17 are placed on the base 16, forming an angle of 90 degrees in a circumferential direction around the rotation axis Lc of the commutator 9. Each of the brush holders 17 is made of metallic material and shaped as a rectangular parallelepiped, in which opposite flanks in a radial direction of the commutator 9 and a face (which corresponds to the bottom face in FIG. 5) opposing the base 16 are open. A pair of restraining portions 17a protruding toward the base 16 are formed integrally with the brush holders 17, and these restraining portions 17a are inserted into restraining holes 16b provided in the base 16 and then bent on a reverse side, thereby fixing the brush holders 17 at predetermined positions located at 90 degrees to each other on the base 16.

A carbon brush 18 (hereinafter simply referred to as a brush) shaped as a rectangular parallelepiped is inserted into each brush holder 17 from an outer circumferential side of the base 16 and held therein, where the brushes 18 are guided by the respective brush holders 17 to be slidable in a radial direction, i.e., in directions orthogonal to the commutator 9. As shown in FIG. 2, one flank of each brush 18 in a circumferential direction is connected with one end of a pigtail 19 for power supply; and the other end of the pigtail 19 is extended over the base 16, penetrates a central portion of a ferrite core 20, and is connected to one end of a coated lead 22 via a soldering point 21. Each coated lead 22 is extended to the outer circumferential side of the base 16 to be connected to a connector (not illustrated), so that power is supplied from the outside via this connector.

One end of the capacitor 23 is connected with the soldering point 21 between each pigtail 19 and coated lead 22, and the other end of the capacitor 23 is connected to the metal case 3. The ferrite cores 20 and capacitors 23 are elements for anti-noise measures, and various elements such as an anti-burnout PTC thermistor and anti-noise varistor are placed on the base 16 although not illustrated.

Also, as described later, the brushes 18 wear gradually during operation of the motor 1 due to sliding contact with an outer circumferential surface of the commutator 9 and the pigtails 19 and the working ends 27b and 28b of the torsion springs 27 and 28 shift their positions gradually toward the commutator 9 as the length of the brushes decreases. Therefore, in order to avoid interference with these members 19, 27b, 28b, slits 17b are formed on opposite flanks of each brush holder 17 in a circumferential direction.

In the narrow-angle region (region within 90 degrees) of the two brush holders 17 on the base 16, a pair of supporting columns 25 and 26 are erected at a same height toward the rear side of the motor 1 in such a way as to adjoin each other on opposite sides of a slight gap G1 in the circumferential direction at equal distances from the respective brush holders 17. Consequently, as shown in FIGS. 2 and 7, the brush holders 17 as well as the supporting columns 25 and 26 are placed in symmetrical positional relationships with each other on opposite sides of an imaginary line La dividing the narrow-angle region of the brush holders 17 extending in the outer circumferential direction from the rotation axis Lc of the commutator 9 into equal halves. The supporting columns 25 and 26 are formed integrally during molding of the base 16.

In the following description, the supporting column on the left side of FIG. 2 will be designated as a first supporting column 25 while the supporting column on the right side of FIG. 2 will be designated as a second supporting column 26 and directions on the base 16 will be defined based on a tip side (corresponding to the rear side of the motor 1) and base side (corresponding to the front side of the motor 1), which are defined with reference to the supporting columns 25 and 26.

As shown in FIGS. 5 to 8, an arc-shaped seating surface 25a (base direction restriction part for the first torsion spring) facing the tip side is formed as a recess in a region surrounding the base end of the first supporting column 25 on the base 16, while a restraining portion 25b (tip direction restriction part for the second torsion spring) is provided protruding in a lateral direction on an outer circumferential surface of a tip end of the first supporting column 25.

On the tip side, the second supporting column 26 is equal in diameter to the first supporting column 25, an expanded-diameter portion 26a larger in diameter than the tip side is formed on the base side, and furthermore a reduced-diameter portion 26b smaller in diameter is formed on the base side of the expanded-diameter portion 26a, extending to a surface on the base side of the base 16 (undersurface in FIG. 8). The expanded-diameter portion 26a and reduced-diameter portion 26b are partially integrated with the base 16, and consequently the second supporting column 26 is erected on the base 16.

As can be seen in planar view in FIG. 7, that part of an outer circumference of the expanded-diameter portion 26a which is located on the side of the first supporting column 25 is flattened by means of a chamfer 26c and the predetermined gap G1 between the supporting columns 25 and 26 described above is maintained even at the location of the expanded-diameter portion 26a. A step is formed between the tip side of the second supporting column 26 and the expanded-diameter portion 26a, and consequently at a tip end of the expanded-diameter portion 26a, a seating surface 26d (base direction restriction part for the second torsion spring) shaped like an arc in planar view is formed facing the tip side.

On the outer circumference of the expanded-diameter portion 26a, a ridge 26e protruding toward the outer circumferential side of the base 16 is formed to extend through the length of the expanded-diameter portion 26a in the axial direction. A step is formed between a base end of the ridge 26e and the reduced-diameter portion 26b, and consequently a restraining portion 26f (tip direction restriction part for the first torsion spring) is formed at the base end of the ridge 26e (which is also a base end of the expanded-diameter portion 26a), facing the base side.

The first torsion spring 27 (hereinafter referred to as the first spring) is supported by the first supporting column 25 and the second torsion spring 28 (hereinafter referred to as the second spring) is supported by the second supporting column 26. As shown in FIG. 5, for the first and second springs 27 and 28, the wound portions 27a and 28a are formed by winding wires such as piano wires or stainless steel spring wires into helical shapes, the working ends 27b and 28b are created by extending ends of the wires on one side from the wound portions 27a and 28a, and the reaction ends 27c and 28c are created similarly by extending ends of the wires on another side from the wound portions 27a and 28a.

According to the present embodiment, the first and second springs 27 and 28 are made of the identical members having the same shape with each other, and supported by the respective supporting columns 25 and 26 in postures inverted from each other.

Inside diameters of the wound portions 27a and 28a of the first and second springs 27 and 28 are set larger than an outside diameter of the first supporting column 25 and an outside diameter of that part of the second supporting column 26 which is closer to the tip end side than the expanded-diameter portion 26a. Also, the gap G1 formed between the two supporting columns 25 and 26 is set slightly larger than the thickness of the wires forming the springs 27 and 28 and slightly smaller than twice the thickness of the wire. Also, the length of the wound portions 27a and 28a of the first and second springs 27 and 28 in the axial direction (which is also the axial direction of the supporting columns 25 and 26) are set slightly smaller than half the length of the first and second supporting columns 25 and 26.

Being fitted in the first supporting column 25, the wound portion 27a of the first spring 27 causes the base end of the wound portion 27a to abut the seating surface 25a of the base 16. Similarly, being fitted in the second supporting column 26, the wound portion 28a of the second spring 28 causes the base end of the wound portion 28a to abut the seating surface 26d of the expanded-diameter portion 26a. Note that since the restraining portion 25b is provided at the tip end of the first supporting column 25, protruding therefrom, the first spring 27 is fitted around the first supporting column 25 by slightly deforming the wound portion 27a and making the wound portion 27a get over the restraining portion 25b gradually.

The reaction end 27c of the first spring 27 is extended from the base side of the wound portion 27a and restrained by an outer circumferential surface of the reduced-diameter portion 26b of the second supporting column 26 while the restraining portion 26f of the second supporting column 26 is placed on the tip side of the reaction end 27c. Therefore, as shown in FIGS. 3 to 4, the first spring 27 is located on the base side of the first supporting column 25 in the axial direction with its movement toward the base direction restricted by the seating surface 25a on the base 16 and with its movement toward the tip direction restricted by the restraining portion 26f.

Also, the reaction end 28c of the second spring 28 is extended from the tip side of the wound portion 28a and restrained by an outer circumferential surface of the first supporting column 25 while the restraining portion 25b of the first supporting column 25 is placed on the tip side of the reaction end 28c of the second spring 28. Therefore, the second spring 28 is located on the tip side of the second supporting column 26 in the axial direction with its movement toward the base direction restricted by the seating surface 26d of the expanded-diameter portion 26a and with its movement toward the tip direction restricted by the restraining portion 25b.

As a result, the first and second springs 27 and 28 are placed in a staggered positional relationship in the side view shown in FIG. 3 and a tip side of the wound portion 27a of the first spring 27 and a base side of the wound portion 28a of the second spring 28 are spaced away from each other in the axial direction of the supporting columns 25 and 26 to form a gap G2. Consequently, as shown in FIG. 6, the respective wires forming the wound portions 27a and 28a of the two springs 27 and 28 are placed in series in the axial direction of the supporting columns 25 and 26 being spaced away from each other by the gap G2 within the gap G1 between the supporting columns 25 and 26.

The working end 27b of the first spring 27 is extended to the corresponding brush 18 from the tip side of the wound portion 27a and bent into a crank shape toward the tip side of the first supporting column 25, thereby being offset toward the tip side. Also, the working end 28b of the second spring 28 is extended to the corresponding brush 18 from the base side of the wound portion 28a and bent into a crank shape toward the base side of the second supporting column 26, thereby being offset toward the base side. Consequently, positions (more specifically, center lines of the respective wires) of the working ends 27b of the two springs 27 and 28 coincide with each other in the axial direction of the supporting columns 25 and 26.

Note that the bending manner to offset the working ends 27b and 28b is not limited to the above manner, and may be changed as desired. For example, regarding angles at which wires are extended toward the brushes 18 from the wound portions 27a and 28a, the working end 27b of the first spring 27 may be set slightly closer to the tip side and the working end 28b of the second spring 28 may be set slightly closer to the base side. Even in this way, the working ends 27b and 28b can be offset similarly.

The first and second springs 27 and 28 have their working ends 27b and 28b abutted against the peripheral edges of the respective brushes 18 with the set loads applied to their wound portions 27a and 28a. As a result, the working ends 27b and 28b of the springs 27 and 28 bias the respective brushes 18 toward the commutator 9 by the elasticity of the wound portions 27a and 28a, while resulting reaction forces are borne by the supporting columns 25 and 26 on the respective opposite sides, by which the reaction ends 27c or 28c are caught and held.

Note that as shown in FIG. 2, the leader portion a of the working end 27b or 28b on the outer circumference of the wound portion 27a or 28a of each spring 27 or 28 is located near the midpoint of the overall length l in the sliding direction of the brush 18 so as to constantly and properly bias the brush 18 which shortens gradually due to wear.

Next, a layout of various members around the supporting columns 25 and 26, which is a characteristic feature of the present embodiment will be described.

The largest feature of the present embodiment is that the reaction ends 27c and 28c are caught and held by the supporting columns on the respective opposite sides 25 and 26 to bear reaction forces when the brushes 18 are biased by the respective working ends 27b and 28b, with the springs 27 and 28 supported on the pair of supporting columns 25 and 26.

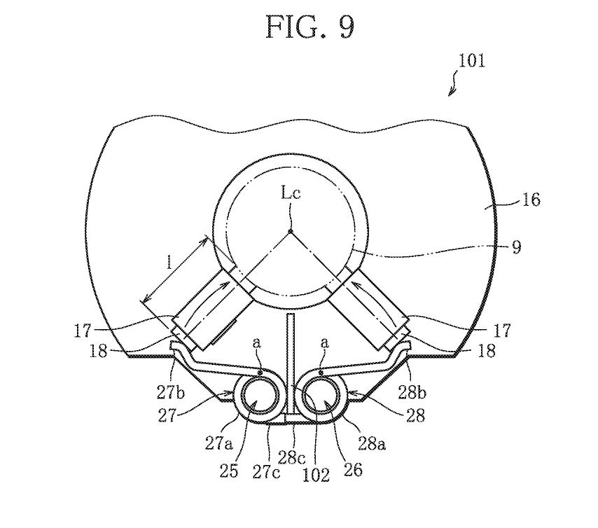

Such mutual use of the supporting columns 25 and 26 by the two springs 27 and 28 eliminates the need to provide the partition wall 102 between the two supporting columns 25 and 26 for use to restrain the reaction ends 27c and 28c of the springs 27 and 28 unlike the conventional technique shown, for example, in FIG. 9. Also, unlike the technique according to Patent Document 1, there is no need to provide a guide wall in addition to a partition wall. As a result, the two supporting columns 25 and 26 can be brought close to each other by a distance equivalent to the thickness of the partition wall 102, thereby making it possible to reduce the occupation area of members around the supporting columns 25 and 26.

Also, since the positions of the supporting columns 25 and 26 with respect to the respective brushes 18 can be set individually, the supporting columns 25 and 26 can be placed at locations as close as possible to the respective brushes 18. Consequently, unlike the technique according to Patent Document 2 in which the supporting column is shared, the supporting columns are not spaced away greatly from the rotation axis of the commutator and the diameter of the base 16 can be reduced. The above factors make it possible to downsize the brush holder device 15 and thus downsize the motor 1 equipped with the brush holder device 15.

In addition, according to the present embodiment, the first and second springs 27 and 28 are placed in a staggered positional relationship and spaced away from each other in the axial direction of the supporting columns 25 and 26. Furthermore, the working end 27b is extended from the tip side of the wound portion 27a of the first spring 27 and is offset toward the tip side by bending while the working end 28b is extended from the base side of the wound portion 28a of the second spring 28 and is offset toward the base side by bending.

Since the first and second springs 27 and 28 are spaced away from each other in the axial direction of the supporting columns 25 and 26, any short circuit caused by contact between the springs 27 and 28 can be prevented reliably. In addition, as shown in FIG. 6, the wires forming the wound portions 27a and 28a of the two springs 27 and 28 are placed in series in the axial direction of the supporting columns 25 and 26 within the gap G1 between the first and second supporting columns 25 and 26, thereby making it possible to bring the supporting columns 25 and 26 close to each other to the maximum.

That is, even when the two springs 27 and 28 are simply installed together, by omitting the partition wall 102 according to the conventional technique of FIG. 9, the present invention makes it possible to bring the two supporting columns 25 and 26 close to each other by a distance equivalent to the thickness of the partition wall 102. However, if the two springs 27 and 28 are placed in a staggered positional relationship, the wires of the springs 27 and 28 are placed in series in the gap G1, thereby making it possible to bring the two supporting columns 25 and 26 close to each other until the spacing nearly reaches the thickness of the wires. Also, the gap G1 formed between the two supporting columns 25 and 26 is slightly larger than the thickness of the wires forming the springs 27 and 28 and slightly smaller than twice the thickness of the wires. This makes it possible to further reduce the occupation area of the members around the supporting columns 25 and 26, and to downsize the brush holder device 15 and thus the motor 1.

Also, although the two springs 27 and 28 themselves are placed in a staggered manner, the working ends 27b and 28b of the springs approach each other in the axial direction of the supporting columns 25 and 26 by being extended from the wound portions 27a and 28a as described above and moreover the two working ends 27b and 28b coincide with each other in the axial direction by being offset by bending. Consequently, by abutting corresponding spots on the respective brushes 18, the two working ends 27b and 28b can bias the brushes 18 under same conditions, thereby causing the brushes 18 to wear equally, and thereby make full use of the original life of the brushes.

Furthermore, to realize such a staggered arrangement of the two springs 27 and 28, the seating surfaces 25a and 26d are formed at the base end of the first supporting column 25 and tip end of the expanded-diameter portion 26a of the second supporting column 26, respectively, and the restraining portions 25b and 26f are formed at the tip end of the first supporting column 25 and base end of the ridge 26e of the second supporting column 26, respectively.

A height difference in the axial direction is produced of on the seating surfaces 25a and 26d of the two supporting columns 25 and 26, thereby naturally placing the two springs 27 and 28 in a staggered positional relationship, and movements of the springs 27 and 28 in the axial direction can be restricted by the seating surfaces 25a and 26d and the restraining portions 25b and 26f. Consequently, the two springs 27 and 28 are placed in a staggered positional relationship and prevented from coming off the supporting columns 25 and 26 using a minimum configuration, which makes it possible to reduce production cost of the springs.

In addition, the staggered arrangement of the two springs 27 and 28 results in another advantage: identical springs can be used as the springs 27 and 28. For example, with the technique according to Patent Document 1, although bilaterally symmetrical springs are placed in parallel, if identical springs are used by being inverted from each other, the respective working ends of the springs are displaced greatly in the axial direction of the supporting columns, resulting in a great discrepancy between points of abutment with the respective brushes, and thus appropriate biasing cannot be hoped for.

In contrast, with a staggered arrangement such as that of the present embodiment, when identical springs 27 and 28 are inverted from each other, the working ends 27b and 28b of the two springs almost coincide with each other in the axial direction and the offset resulting from bending acts in a desirable direction to further bring the two working ends 27b and 28b close to each other. That is, if placed in a staggered manner, identical springs 27 and 28 can be used without causing negative effects. This provides various advantages such as a reduction in the production cost of the springs 27 and 28 or prevention of misassembly onto the base 16.

In addition, as shown in FIG. 3, since the seating surface 25a of the first supporting column 25 is formed as a recess on the base 16, the wound portion 27a of the first spring 27 is half-buried in the base 16 with part (about half in the axial direction) of it being placed below a top face of the base 16. Consequently, the first spring 27 can be disposed at a lower position and the second spring 28 can also be disposed at a lower position with the gap G2 secured than when the seating surface 25a is not formed as a recess. As a result, length of the supporting columns 25 and 26 in the axial direction can be kept down and the brush holder device 15 can be further downsized.

This concludes description of the embodiment, but aspects of the present invention are not limited to the embodiment. For example, in the embodiment described above, the present invention has been embodied as the brush holder device 15 in which a pair of brushes 18 are placed at a 90-degree interval and as a 4-pole DC motor 1 equipped with the brush holder device 15 and used for an automotive power window, but applications and types of the motor 1 are not limited to this and may be changed as desired. For example, the present invention is applicable to motors for use to drive sunroofs or slide doors, motors for power tools, and the like.

Also, the present invention may be applied to a 2-pole DC motor in which the brushes 18 are placed at a 180-degree interval or an 8-pole DC motor in which the brushes 18 are placed at a 45-degree interval. Also, the present invention may be applied to a 6-pole DC motor in which the brushes 18 are placed at a 60-degree or 120-degree interval. Furthermore, the present invention may be applied to a 4-pole DC motor in which two pairs of brushes 18 (four in total) are placed at a 90-degree interval each. In that case, one more set of the components according to the above embodiment, including the brush holders 17, supporting columns 25 and 26, and springs 27 and 28 can be added to the base 16.

Also, in the above embodiment, the first and second springs 27 and 28, which are identical springs with each other, are used by being inverted from each other and placed in a staggered manner, but this is not necessarily the case. For example, as with the technique according to Patent Document 1, bilaterally symmetrical springs may be placed in parallel. Even in this case, if the reaction ends of the two springs are restrained by the supporting columns on the respective opposite sides 25 and 26 as with the above embodiment, similar operation and effects can be achieved.

Also, whereas in the above embodiment, the first and second springs 27 and 28 are not only placed in a staggered manner, but also spaced away from each other in the axial direction of the supporting columns 25 and 26 to prevent short circuits, if insulation measures are provided between the two brushes 18, it is not strictly necessary to space away the springs from each other. Specifically, if either or both of the springs 27 and 28 are insulation-coated with enamel or the like or insulating material is pasted to the brushes 18 abutted by the reaction ends 27c and 28c, electrical insulation can be secured, and thus the two springs 27 and 28 may be placed in contact.

### INDUSTRIAL APPLICABILITY

The present invention is applicable to motors used for automotive power windows or sunroofs, power tools, or the like.

### EXPLANATION OF REFERENCE SIGNS

1 DC motor
9 Commutator
16 Base
17 Brush holder
18 Carbon brush
25 First supporting column
26 Second supporting column
25a, 26d Seating surface (base direction restriction part)
25b, 26f Restraining portion (tip direction restriction part)
27 First torsion spring
28 Second torsion spring
27a, 28a Wound portion
27b, 28b Working end
27c, 28c Reaction end

1. A brush holder device comprising:
a pair of brush holders placed on a base to slidably hold brushes, respectively, in directions orthogonal to an outer circumferential surface of a commutator;
first and second supporting columns erected next to each other in a region between the pair of brush holders; and
first and second torsion springs including wound portions around the respective supporting columns, first ends extendable from the wound portions to abut against the brushes as working ends, and second ends extending from the wound portions to be restrained by outer circumferential surfaces of the supporting columns on respective opposite sides as reaction ends.

2. The brush holder device according to claim 1, wherein the first torsion spring is positioned on a base side of the first supporting column, the second torsion spring is positioned on a tip side of the second supporting column, the torsion springs are placed in such a positional relationship with each other as to differ in height in an axial direction, the working end of the first torsion spring is extended from the tip side of the wound portion of the first torsion spring, and the working end of the second torsion spring is extended from the base side of the wound portion of the second torsion spring.

3. The brush holder device according to claim 2, wherein the first and second supporting columns include a tip direction restriction part and a base direction restriction part respectively formed on each of the first and second supporting columns to restrict movements of the first and second torsion springs so that the torsion springs are positioned on the base side or the tip side of the supporting columns, respectively, to be spaced away from each other in an axial direction of the supporting columns.

4. The brush holder device according to claim 3, wherein:
the base direction restriction part for the first torsion spring is a first seating surface formed at a base end of the first supporting column on the base to be abutted by the wound portion of the first torsion spring;
the base direction restriction part for the second torsion spring is a second seating surface formed at a tip end of an expanded-diameter portion of the second supporting column to be abutted by the wound portion of the second torsion spring;
the tip direction restriction part for the first torsion spring is a first restraining portion formed at a base end of the expanded-diameter portion of the second supporting column and located on a tip side of the reaction end of the first torsion spring; and
the tip direction restriction part for the second torsion spring is a second restraining portion formed at a tip end of the first supporting column and located on a tip side of the reaction end of the second torsion spring.

5. The brush holder device according to claim 3, wherein the extended portion from the wound portion of the first torsion spring is bent toward the tip side of the first supporting column and the extended portion from the wound portion of the second torsion spring is bent toward the base side of the second supporting column.

6. The brush holder device according to claim 2, wherein the first and second torsion springs are formed of identical members having the same shape with each other, and the wound portions are fitted in the respective supporting columns in postures inverted from each other.

7. The brush holder device according to claim 2, wherein a gap formed between the first and second supporting columns is larger than a thickness of wires forming the first and second torsion springs and smaller than twice the thickness of the wires.

8. A DC motor comprising:
a housing;
a rotor including a rotating shaft, an armature, and a commutator; and
a brush holder device,
wherein the brush holder device including:
a base supported by a housing,
a pair of brush holders placed on the base to slidably hold brushes, respectively, in directions orthogonal to an outer circumferential surface of the commutator,
first and second supporting columns erected next to each other in a region between the pair of brush holders, and
first and second torsion springs including wound portions fit around the respective supporting columns, first ends extendable from the wound portions to abut against the brushes as working ends, and second ends extended from the wound portions to be restrained by outer circumferential surfaces of the supporting columns on the respective opposite sides as reaction ends.
